(19) United States
(12) Patent Application Publication
(10) Pub. No.: US 2010/0271567 A1
(43) Pub. Date: Oct. 28, 2010

(54) ILLUMINATION DEVICE AND LIQUID CRYSTAL DISPLAY DEVICE

(76) Inventors: Naru Usukura, Osaka (JP); Takehiro Murao, Osaka (JP)

Correspondence Address: BIRCH STEWART KOLASCH & BIRCH, PO BOX 747, FALLS CHURCH, VA, 22040-0747, US

(21) Appl. No.: 12/810,673

(22) PCT Filed: Dec. 19, 2008
(86) PCT No.: PCT/JP2008/003866

§ 371 Date: Jun. 25, 2010

(30) Foreign Application Priority Data
Dec. 28, 2007 (JP) 2007-340879

(51) Int. Cl. G02F 1/1335; F21V 7/22

(52) U.S. Cl. 349/62; 362/606

(57) ABSTRACT

An illuminator 10 according to the present invention includes a light source 14 for emitting light, a light guide plate 12 for propagating the emitted light, and a prism sheet 18 having a plurality of prisms 26 for refracting the light propagated through the light guide plate 12. The prism sheet includes anisotropic particles 31 having diffusion anisotropy. Regarding in-plane directions of the prism sheet 18, an arraying direction 18a of the plurality of prisms 26 and a major axis direction 31a of the anisotropic particles are shifted by an angle which is greater than 0 degrees and smaller than 5 degrees. This makes it possible to efficiently suppress occurrence of moire while suppressing spread of a half-luminance angle of light.

### TECHNICAL FIELD

The present invention relates to an illuminator and a liquid crystal display device.

### BACKGROUND ART

In recent years, liquid crystal display devices are widely used as display devices of monitors, projectors, mobile information terminals, mobile phones, and the like. Generally speaking, a liquid crystal display device allows the transmittance (or reflectance) of a liquid crystal display panel to vary with a driving signal, thus modulating the intensity of light from a light source which is radiated onto the liquid crystal display panel, whereby images or text is displayed. Liquid crystal display devices include: the direct-viewing type display device, in which images and the like which are displayed on a liquid crystal display panel are to be viewed directly; the projection-type display device (projector), in which images and the like which are displayed on a liquid crystal display panel are projected by a projection lens onto a screen in an enlarged size; and so on.

By applying a driving voltage corresponding to an image signal to each of the pixels which are regularly arrayed in a matrix shape, a liquid crystal display device allows the optical characteristics of a liquid crystal layer to vary in each pixel, and with polarizers (which typically are polarizing plates) being placed in the front and the rear, regulates transmitted light in accordance with the optical characteristics of the liquid crystal layer, thereby displaying images, text, and the like. In a direct-viewing type liquid crystal display device, these polarizing plates are usually directly attached respectively to a light-incident-side substrate (rear substrate) and a light-outgoing-side substrate (front substrate or viewer-side substrate) of the liquid crystal display panel.

Methods for applying independent driving voltages to the respective pixels include the passive matrix method and the active matrix method. Among these, in a liquid crystal display panel according to the active matrix method, switching elements and wiring lines for supplying driving voltages to pixel electrodes need to be provided. As the switching elements, non-linear 2-terminal devices such as MIM (metal-insulator-metal) devices and 3-terminal devices such as TFT (thin film transistor) devices are being used.

It is known that moire occurs in a liquid crystal display device because of a pitch of prisms used for a backlight and a pitch of the pixels of a liquid crystal panel, and it is necessary to provide countermeasures against moire in order to suppress occurrence of this moire.

Examples of countermeasures against moire may be methods such as diffusing light by using a diffusion sheet, selecting pitches for the prisms and the pixels such that moire is unlikely to occur therebetween, broadening the interspace between the prisms and the liquid crystal panel, and so on.

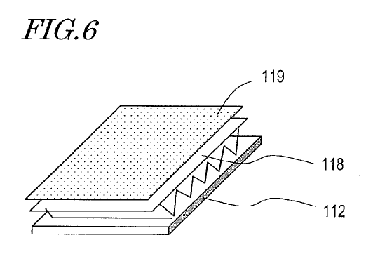

With reference to FIG. 6, a construction for diffusing light by using a diffusion sheet, as a countermeasure against moire, will be described. FIG. 6 is a diagram showing an illuminator to be mounted in a liquid crystal display device. The illuminator includes a diffusion sheet 119 for diffusing light. Light entering a liquid crystal panel (not shown) from a light guide plate 112 by passing through a prism sheet 118 is diffused when passing through the diffusion sheet 119, whereby occurrence of moire can be suppressed. Moreover, Patent Document 1 proposes an illuminator which, by using an anisotropic scattering plate as a diffusion sheet, suppresses decrease in luminance while suppressing occurrence of moire.

[Patent Document 1] Japanese Laid-Open Patent Publication No. 2002-40418

### DISCLOSURE OF INVENTION

### Problems to be Solved by the Invention

In order to effectively utilize light from a backlight of a liquid crystal display device, adoption of a microlens array (MLA) is being considered. In the case where a microlens array is mounted in a direct-viewing type liquid crystal display device, moire is emphasized due to the influence of a light converging action of the lenses. As a backlight for a microlens array, it is desirable to use a backlight having a narrow half-luminance angle in order to enhance the light converging effect of the lenses, and thus a reverse prism type (TL type) backlight is used to narrow the half-luminance angle along the lens curvature direction. Therefore, merely employing a diffusion sheet for diffusing light will increase the half-luminance angle, and thus reduce the effect of the microlens array. Moreover, presence of a diffusion sheet all over the displaying region is a factor leading to a lowered luminance. Moreover, since an anisotropic scattering plate has a generally inferior diffusibility to that of an isotropic diffusion sheet, under conditions where moire will be emphasized by the microlens array, merely using an anisotropic scattering plate as a diffusion sheet provides an inadequate effect of suppressing moire.

Moreover, from a production standpoint, it is not easy to design an arbitrary prism pitch, and when the relationship between the screen size and the number of pixels is taken into consideration, it is also difficult to designate an arbitrary pixel pitch. Moreover, broadening the interspace between the prisms and the liquid crystal panel will not be appropriate for a liquid crystal display device which is required to be thin.

The present invention has been made in view of the above problems, and provides an illuminator and liquid crystal display device which efficiently suppresses occurrence of moire while suppressing spread of a half-luminance angle of light.

### Means for Solving the Problems

An illuminator according to the present invention comprises: a light source for emitting light; a light guide plate for propagating the emitted light; and a prism sheet including a plurality of prisms for refracting light propagated through the light guide plate, characterized in that the prism sheet includes anisotropic particles having diffusion anisotropy; and regarding in-plane directions of the prism sheet, an arraying direction of the plurality of prisms and a longitudinal direction of the anisotropic particles are shifted by an angle which is greater than 0 degrees and smaller than 5 degrees.

In one embodiment, regarding in-plane directions of the prism sheet, the arraying direction of the plurality of prisms and the longitudinal direction of the anisotropic particles are shifted by an angle of no less than 1 degree and no more than 4 degrees.

In one embodiment, the illuminator is a reverse prism type backlight.

A liquid crystal display device is characterized by comprising: the aforementioned illuminator; and a liquid crystal panel having a pair of substrates and a liquid crystal layer interposed between the pair of substrates.

One embodiment further comprises a plurality of microlenses provided between the liquid crystal panel and the illuminator.

### Effects of the Invention

According to the present invention, a prism array includes anisotropic particles having diffusion anisotropy, and, regarding in-plane directions of the prism array, an arraying direction of the prism array and a longitudinal direction of the anisotropic particles are shifted by an angle which is greater than 0 degrees and smaller than 5 degrees. As a result, moire can be efficiently suppressed while suppressing spread of a half-luminance angle, and a liquid crystal display device having a high efficiency and a high display quality can be provided.

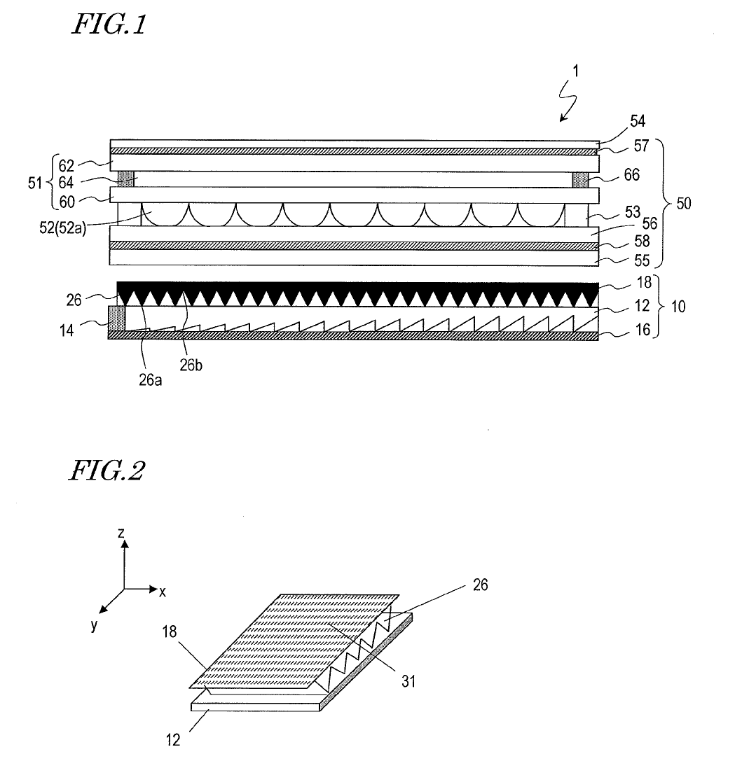

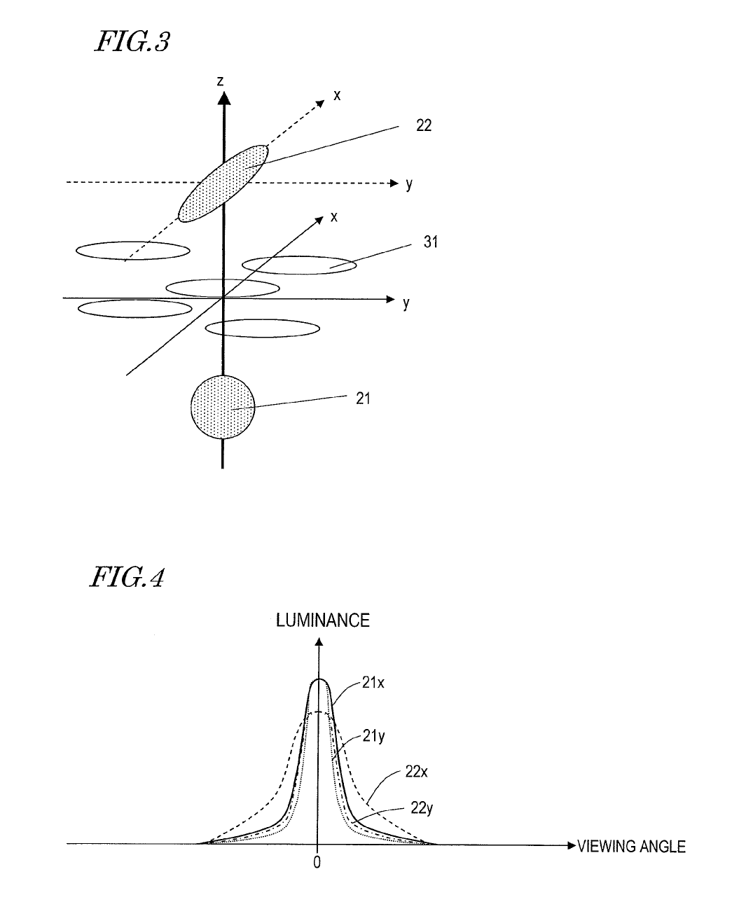

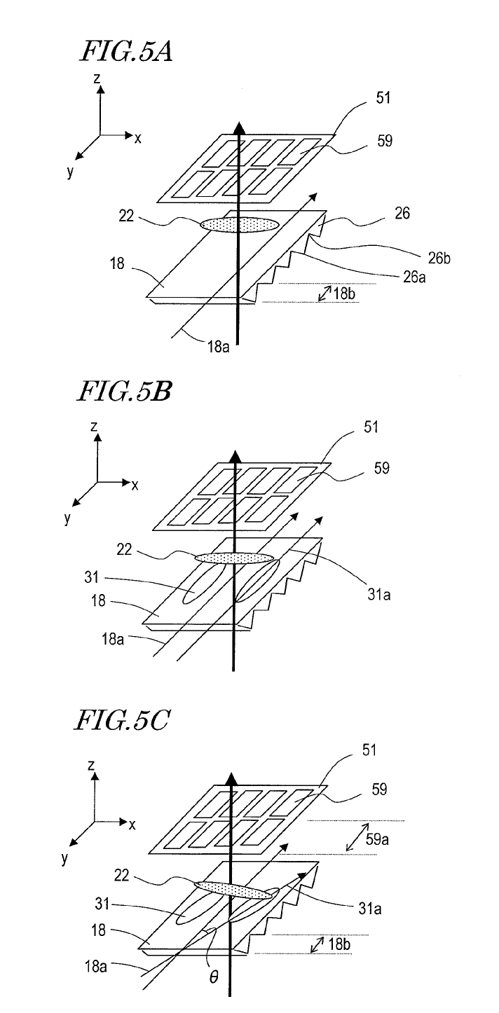

### BRIEF DESCRIPTION OF DRAWINGS

[FIG. 1] A cross-sectional view showing a liquid crystal display device according to an embodiment of the present invention.

[FIG. 2] A perspective view showing a prism sheet including anisotropic particles according to an embodiment of the present invention.

[FIG. 3] A diagram showing how filler needles according to an embodiment of the present invention may diffuse light.

[FIG. 4] A diagram showing how transmitted light may be diffused according to an embodiment of the present invention.

[FIG. 5A] A perspective view showing light transmitted through a prism sheet according to an embodiment of the present invention.

[FIG. 5B] A perspective view showing light transmitted through a prism sheet including filler needles according to an embodiment of the present invention.

[FIG. 5C] A perspective view showing biased filler needles according to an embodiment of the present invention, and light transmitted through a prism sheet including the filler needles.

[FIG. 6] A diagram showing a diffusion sheet for diffusing light.

### DESCRIPTION OF REFERENCE NUMERALS

1 liquid crystal display device

10 illuminator

18 prism sheet

18a arraying direction of prisms

21 incident light

22 transmitted light

26 prism

31 anisotropic particles (filler needles)

31a major axis direction of filler needle

50 liquid crystal display panel

51 liquid crystal panel

52 microlens array

52a microlens

59 pixel

### BEST MODE FOR CARRYING OUT THE INVENTION

Hereinafter, with reference to the drawings, an embodiment of an illuminator and liquid crystal display device according to the present invention will be described.

FIG. 1 is a cross-sectional view showing a liquid crystal display device 1 according to an embodiment of the present invention. The liquid crystal display device 1 includes a liquid crystal display panel (liquid crystal panel with microlenses) 50 and an illuminator 10 provided below (on an opposite face from the display surface) the liquid crystal display panel 50.

The illuminator 10 includes a light guide plate 12, LEDs (Light Emitting Diodes) 14 which are light sources provided on one side face of the light guide plate 12, a reflector 16 provided below the light guide plate 12, and a prism sheet 18 above (closer to the liquid crystal panel) the light guide plate 12.

A plurality of slopes are formed in a lower portion of the light guide plate 12 facing the reflector 16, such that the plurality of slopes have increasing tilting angles away from the LEDs 14. The positioning of the slopes is exemplary, and the slopes may be provided in an upper portion of the light guide plate 12. Alternatively, the slopes may be formed in a direction which is orthogonal to a light-incident face of the light guide plate 12.

Instead of LEDs 14, cold-cathode tubes may be used as the light sources, and the LEDs 14 may be disposed at corner portions sandwiched between two side faces of the light guide plate 12.

The prism sheet 18 is a prism array including a plurality of prisms 26 arrayed in an arbitrary direction. The illuminator 10 is a backlight of a reverse prism type, each prism 26 having a peak portion 26a which is pointed downward. Valley portions (groove portions) 26b are provided between peak portions 26a.

Light going out from the LEDs 14 propagate through the light guide plate 12, and after being reflected by the reflector 16 or the slopes of the light guide plate 12, travels through an upper face (outgoing face) of the light guide plate 12, and is refracted by the prisms 26 of the prism sheet 18, thus being emitted toward the liquid crystal display panel 50, which is provided above the prism sheet 18.

The liquid crystal display panel 50 includes: a liquid crystal panel (composite substrate) 51 having a plurality of pixels disposed in a matrix shape; a microlens array 52 including a plurality of microlenses 52a provided on a light-receiving face of the liquid crystal panel 51 (a bottom face of the liquid crystal panel 51 extending perpendicular to the plane of the figure); supports 53 provided in a peripheral region of the microlens array 52; a front-face optical film 54 provided on the viewer side (upper side in the figure) of the liquid crystal panel 51; a rear-face optical film 55 provided on the light-incident side of the microlens array 52; and a protection layer 56 interposed between the rear-face optical film 55 and the microlens array 52. The microlens array 52 is interposed between the liquid crystal panel 51 and the illuminator 10.

The protection layer 56 is composed of a photocurable resin, and is in contact with the microlens array 52 and the supports 53. The protection layer 56 and the microlens array 52 are attached so that the protection layer 56 is only in contact with the neighborhood of the apex of each microlens 52a.

The front-face optical film 54 is attached to the liquid crystal panel 51 via an adhesion layer 57, whereas the rear-face optical film 55 is attached to the protection layer 56 via an adhesion layer 58. Note that each of the front-face optical film 54 and the rear-face optical film 55 has a polarization film which transmits linearly polarized light.

The protection layer 56 is composed of an acryl-type or epoxy-type UV-curing resin having a high transmittance for visible light, but may also be composed of a thermosetting resin. Preferably, the protection layer 56 and the supports 53 are composed of the same material as that of the microlenses 52a, or a material having substantially the same refractive index as the refractive index of the material composing the microlenses 52a.

The liquid crystal panel 51 includes an electrical device substrate 60 on which a switching element (e.g., a TFT or MIM device) is formed for each pixel, a counter substrate 62 which is e.g. a color filter substrate (CF substrate), and a liquid crystal layer 64. The liquid crystal layer 64 includes a liquid crystal material which is contained between the electrical device substrate 60 and the counter substrate 62, and is sealed with a sealant 66 which is provided in the outer periphery.

The microlenses 52a of the microlens array 52 are lenticular lenses extending so as to correspond to columns of pixels provided in a matrix shape on the liquid crystal panel (a perpendicular direction to the plane of the figure). Although depending on the model, the pixel pitch (the width of one pixel) is about 50 to 300 μm, and the width of the microlenses 52a is also a width corresponding to the pixel pitch.

Next, the prism sheet 18 will be described in more detail. FIG. 2 is a perspective view showing the prism sheet 18. The prism sheet 18 includes a plurality of anisotropic particles 31 having diffusion anisotropy. The anisotropic particles 31 are filler needles, for example.

A prism sheet 18 in which such filler needles 31 are disposed can be produced by using a tackiness agent in which the filler needles 31 are mixed, for example. It is desirable that the tackiness agent has a high optical transparency; for example, an acryl-type tackiness agent or the like can be used. The main component of the acryl-type tackiness agent may be, for example: a homopolymer of an acrylic monomer such as acrylic acid and its ester, methacrylic acid and its ester, acrylamide, or acrylonitrile, or a copolymer thereof; a copolymer between at least one kind of acrylic monomer and a vinyl monomer such as vinyl acetate, maleic anhydride, styrene, or the like; and so on.

The filler needles 31 are pieces of filler having a different refractive index from that of the tackiness agent and having needle shapes (including fibrous shapes) with a high aspect ratio, and are preferably colorless or white in order to prevent coloration of transmitted light. As the filler needles 31, needle-like or fibrous pieces composed of a metal oxide such as titanium oxide, zirconium oxide, or zinc oxide, a metal compound such as boehmite, aluminum borate, calcium silicate, basic magnesium sulfate, calcium carbonate, or potassium titanate, glass, or a synthetic resin are suitably used, for example. A filler needle 31 is sized so that it has a longer diameter of 2 to 5000 μm and a shorter diameter of 0.1 to 20 μm, for example, and more preferably has a longer diameter of 10 to 300 μm and a shorter diameter of 0.3 to 5 μm.

One method of producing a prism sheet 18 in which the filler needles 31 are disposed may be a method of preparing a filler-containing adhesive composition including filler needles 31 dispersed in a tackiness agent, using this to coat the prism sheet 18, and thereafter removing the solvent by drying, for example. Furthermore, as necessary, about 1 day or 2 weeks of curing may be performed in a temperature environment at room temperature or about 30 to 60° C., in order to solidify or stabilize the tackiness agent component.

When the filler-containing adhesive composition is used for coating, each filler needle 31 is aligned so that its major axis is substantially along the direction of coating, due to a shearing force which acts on the filler-containing adhesive composition. Thus, it is possible to set the orientations of the filler needles 31 based on the direction of coating. Note that the degree of alignment of the filler needles can be adjusted based on the size of the filler needles, the viscosity of the filler-containing adhesive composition, the coating method, the coating speed, and the like. A filler-containing layer which is composed of a filler-containing adhesive composition has a thickness of 1 to 50 μm, for example, and more preferably 10 to 30 μm.

Alternatively, a prism sheet 18 in which the filler needles 31 are disposed may be produced by mixing the filler needles 31 in an acryl-type or epoxy-type resin which is UV-curing or thermosetting, using such a resin containing the filler needles 31 to coat the prism sheet 18, and solidifying it by applying ultraviolet or heat. In this case, too, it is possible to set the orientations of the filler needles 31 based on the direction of coating.

FIG. 3 is a diagram showing how the anisotropic particles (filler needles) 31 may diffuse light. When isotropic light 21 is incident on the filler needles 31, the light 21 is diffused by the filler needles 31. The filler needles 31 have characteristics such that they do not much diffuse the light 21 along their major axis direction (y direction), but greatly diffuse the light 21 along their minor axis direction (x direction). Therefore, the light 22 transmitted through the filler needles 31 is anisotropic diffused light which is greatly diffuse along the x direction but not much diffused along the y direction.

FIG. 4 is a diagram showing how the transmitted light 22 may be diffused. In the example shown in FIG. 4, incident light 21 is light which has been transmitted through the prisms 26, and an x-direction component 21x of the incident light 21 is slightly more diffused than a y-direction component 21y thereof. It can be seen that the x-direction component 22x of the transmitted light 22, which has been transmitted through the filler needles 31, is greatly diffused relative to the incident light 21. It can be seen that the y-direction component 22y of the transmitted light 22 is hardly diffused relative to the incident light 21, thus having a smaller degree of diffusion than that of the x-direction component 22x.

Next, with reference to FIG. 5A to FIG. 5C, an angle between an arraying direction of the plurality of prisms 26 and a longitudinal direction of the filler needles will be described. FIG. 5A is a perspective view illustrating light transmitted through the prism sheet 18. An arraying direction 18a of the plurality of prisms 26 is a direction along the y direction, and is also a direction of a pitch 18b between the prisms 26. The peak portion 26a and the valley portion (groove portion) 26b of each prism 26 extend along the x direction. A plurality of pixels 59 of the liquid crystal panel 51 are arrayed along the x direction and the y direction.

For the sake of illustration, FIG. 5A shows the prism sheet 18 as not containing any filler needles 31. Due to the action of the plurality of prisms 26, the light 22 transmitted through the reverse prism type prism sheet 18 has become anisotropic diffused light which is not much diffused along the y direction but is greatly diffused along the x direction.

FIG. 5B is a perspective view illustrating light transmitted through a prism sheet 18 including filler needles 31. In the example shown in FIG. 5B, the filler needles 31 are formed so that a major axis direction 31a of the filler needles 31 is parallel to an arraying direction 18a (y direction) of the prisms 26. So as to maintain the tendency of diffusion along the x direction and the y direction of light 22 transmitted through the prism sheet 18, the filler needles 31 do not much diffuse the light 22 along the y direction but greatly diffuse the light 22 along the x direction.

FIG. 5C is a perspective view illustrating biased filler needles 31 and light transmitted through a prism sheet including the filler needles 31. Regarding in-plane directions (xy in-plane directions) of the prism sheet 18, a major axis direction 31a of the filler needles 31 is shifted by an angle θ from an arraying direction 18a (y direction) of the prisms 26.

Moire occurs due to a relationship between a period of a pitch 18b of the prisms 26 and a period of a pixel pitch 59a. Therefore, by allowing the major axis direction 31a of the filler needles 31 to be shifted by the angle θ from the arraying direction 18a of the prisms 26, and shifting the direction along which the transmitted light 22 is diffused by rotation (shifting the direction along which anisotropy is exhibited by rotating), occurrence of moire can be suppressed. It is desirable that, by allowing the major axis direction 31a of the filler needles 31 to be shifted from the arraying direction 18a of the prisms 26, the direction along which the transmitted light 22 is diffused is rotated approximately by the angle θ.

Thus, by allowing the transmitted light 22 to be greatly diffused along a certain direction (x direction), occurrence of moire can be suppressed; and by reducing diffusion along another direction (y direction), decrease in luminance can be suppressed and also the light converging effect by the microlenses 52a (FIG. 1) can be enhanced. Furthermore, occurrence of moire can also be suppressed by conferring a bias to the filler needles 31 as described above, whereby occurrence of moire can be efficiently suppressed.

Note that the angle θ between the major axis direction 31a of the filler needles 31 and the arraying direction 18a of the prisms 26 is also an angle between the minor axis direction of the filler needles 31 and the direction along which the groove portions 26b of the prisms 26 extend (x direction).

The angle θ between the major axis direction 31a of the filler needles 31 and the arraying direction 18a of the prisms 26 is preferably greater than 0 degrees and smaller than 5 degrees, and more preferably no less than 1 degree and no more than 4 degrees. If it is 0 degrees, the spread of a half-luminance angle is small and light can be utilized highly efficiently, but the moire suppression effect is small. If it is 5 degrees, the moire suppression effect is high, but the spread of the half-luminance angle is large, and the efficiency of light utility becomes lower.

The diffusibility of anisotropic diffusion can be discussed in terms of haze values. The haze value is desirably 10% to 40%. If it is 10%, the spread of the half-luminance angle is small, but the moire suppression effect is small. If it is 40%, the moire suppression effect is high, but the half-luminance angle has a large spread, and the efficiency of light utility becomes lower.

More desirably, the filler needles 31 are biased in a direction such that the direction of light spread coincides with the direction of the transmission axis of a polarizing plate.

Although the above-described embodiment illustrates a reverse prism type illuminator as an example, the present invention is not limited thereto. The present invention is also applicable to an illuminator of a method in which one or more BEF (Brightness Enhancement Film) are used (e.g. BEF-BEF method), for example.

### INDUSTRIAL APPLICABILITY

The present invention is particularly useful in the technological fields of liquid crystal display devices and illuminators to be mounted in liquid crystal display devices.

1. An illuminator comprising:
a light source for emitting light;
a light guide plate for propagating the emitted light; and
a prism sheet including a plurality of prisms for refracting light propagated through the light guide plate, wherein,
the prism sheet includes anisotropic particles having diffusion anisotropy; and
regarding in-plane directions of the prism sheet, an arraying direction of the plurality of prisms and a longitudinal direction of the anisotropic particles are shifted by an angle which is greater than 0 degrees and smaller than 5 degrees.

2. The illuminator of claim 1, wherein, regarding in-plane directions of the prism sheet, the arraying direction of the plurality of prisms and the longitudinal direction of the anisotropic particles are shifted by an angle of no less than 1 degree and no more than 4 degrees.

3. The illuminator of claim 1, wherein the illuminator is a reverse prism type backlight.

4. A liquid crystal display device comprising:
the illuminator of claim 1; and
a liquid crystal panel having a pair of substrates and a liquid crystal layer interposed between the pair of substrates.

5. The liquid crystal display device of claim 4, further comprising a plurality of microlenses provided between the liquid crystal panel and the illuminator.
